(19) United States
(12) Patent Application Publication
(10) Pub. No.: US 2025/0284991 A1
(43) Pub. Date: Sep. 11, 2025

(54) QUANTUM GATE FOR CONTROL AND ENTANGLEMENT OF MULTIMODE SYSTEMS

(71) Applicant: Nord Quantique Inc., Sherbrooke (CA)

(72) Inventors: Dany Lachance-Quirion, Sherbrooke (CA); Mark-Antoine Lemonde, Sherbrooke (CA); Pascal Lemieux, Sherbrooke (CA); Sandoko Kosen, Sherbrooke (CA); Nicholas Frattini, Sherbrooke (CA)

(21) Appl. No.: 19/067,306

(22) Filed: Feb. 28, 2025

Related U.S. Application Data
(60) Provisional application No. 63/562,026, filed on Mar. 6, 2024.

(51) Int. Cl. G06N 10/20; G06N 10/40

(52) U.S. Cl. CPC G06N 10/20; G06N 10/40

(57) ABSTRACT

Disclosed herein are systems and methods for quantum gate control and entanglement of multimode systems. In an embodiment, the quantum gate systems and methods may comprise a single non-linear superconducting element, coupled to one or more linear modes; a multimode ECD protocol, the multimode ECD protocol configured to selectively drive one or more linear modes in order to achieve an entangling gate between the one or more linear modes.

### CROSS-REFERENCE TO RELATED APPLICATIONS

This application claims priority to U.S. Provisional Patent Application No. 63/562,026, filed Mar. 6, 2024, which is hereby incorporated by reference in its entirety.

### FIELD OF INVENTION

The present disclosure relates to quantum computing systems, and, in particular, to a quantum gate for control and entanglement of multimode systems.

### BACKGROUND

Bosonic codes provide a promising route for hardware-efficient quantum computing when compared with traditional approaches using few-level systems as qubits. The larger number of levels in bosonic systems provides room for redundancy within a single physical system, enabling one to perform quantum error correction at the single-qubit level, something impossible with a two-level system qubit. Furthermore, the dominant source of noise in most physical implementations of harmonic oscillators is photon loss, a type of error for which bosonic codes can be made tolerant to first order and the like.

However, bosonic codes require a universal control on a set of bosonic modes. The bosonic modes are typically embodied into high-Q superconducting cavities. These cavities are controlled by a non-linear superconducting element. The superconducting element is often chosen to be a transmon qubit dispersively coupled to the cavity. Set of quantum gates of particular interest allow universal control of the cavities quantum state. In that framework, a well-known type of control gate, the echoed conditional displacement (ECD) gate, has been realized in single-mode systems only (Lachance-Quirion, D., Lemonde, M.-A., Simoneau, J. O., St-Jean, L., Lemieux, P., Turcotte, S., Wright, W., Lacroix, A., Fréchette-Viens, J., Shillito, R., Hopfmueller, F., Tremblay, M., Frattini, N. E., Lemyre, Julien Camirand, & St-Jean, P. (2023). Autonomous quantum error correction of Gottesman-Kitaev-Preskill states. ArXiv (Cornell University). https://doi.org/10.48550/arxiv.2310.11400).

However, it would be desirable to employ ECD methods with a similar capacity control and entanglement, for systems composed of multiple modes.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concepts described herein to provide a basic understanding of some aspects of the disclosure. This summary is not an extensive overview of the disclosure. It is not intended to restrict key or critical elements of embodiments of the disclosure to delineate their scope beyond that which is explicitly or implicitly described by the following description and claims.

A need exists for a quantum gate for control and entanglement of multimode systems.

In accordance with an aspect of the disclosure, there is provided a system for control and entanglement of multimode quantum computing devices, the system comprising: a single non-linear superconducting element coupled to one or more linear modes; a controller coupled to the single non-linear superconducting element and configured to perform, via a driving hardware, a multimode Echoed Conditional Displacement (ECD) protocol, the multimode ECD protocol configured to selectively drive the one or more linear modes in order to achieve an entangling gate between the one or more linear modes.

In accordance with an aspect of the disclosure, the multimode ECD may comprise a first set of displacement drives of amplitude αₙ in phase space of each of n modes involved in the multimode ECD protocol; the first set of displacement drives being followed by one or more of: a wait time, an additional displacement drive of −αₙ, π-pulse on the auxiliary qubit, a −αₙ displacement pulse, a ζαₙ pulse with ζ being a correction factor, and a virtual Z-gate on the auxiliary qubit.

In accordance with an aspect of the disclosure, the amplitudes and wait time of the pulses in the sequences can be adjusted differently.

In accordance with an aspect of the disclosure, the timing between pulses can vary from sequence to sequence.

In accordance with an aspect of the disclosure, the multimode ECD can be used to realize other entangling operation or protocol, providing universal control over the multimode system.

In accordance with an embodiment of the disclosure, the single, non-linear superconducting element comprises a single transmon.

In accordance with an embodiment of the disclosure, the one or more linear modes comprise: superconducting cavities, resonators, or a combination thereof.

In accordance with an embodiment of the disclosure, the single transmon is coupled to a plurality of cavities, resonators, or a combination thereof.

In accordance with an embodiment of the disclosure, the single transmon is coupled to a plurality of modes in a single cavity or resonator.

In accordance with an embodiment of the disclosure, the cavity comprises a multi-post cavity.

In accordance with an embodiment of the disclosure, the single transmon is coupled to a plurality of modes, the plurality of modes being in a plurality of separated cavities, resonators, or a combination thereof.

In accordance with an embodiment of the disclosure, the single transmon is coupled to one mode per cavity.

In accordance with an embodiment of the disclosure, the single transmon is coupled to one or more multimode cavities, the one or more multimode cavities being coupled to one or more non-linear elements.

In accordance with an embodiment of the disclosure, the one or more non-linear comprising one or more qubits. In accordance with an embodiment of the disclosure, a calibration of the system comprises: one or more single mode ECD calibration steps.

In accordance with another aspect of the disclosure, there is provided a method of controlling and entangling a multimode system, the method comprising selectively driving, via a multimode ECD protocol, one or more linear modes, the one or more linear modes coupled to a single non-linear superconducting element, in order to achieve an entangling gate between the one or more linear modes.

In accordance with an embodiment of the disclosure, the single, non-linear superconducting element comprises a single transmon.

In accordance with an embodiment of the disclosure, the one or more linear modes comprise: superconducting cavities, resonators, or a combination thereof.

In accordance with an embodiment of the disclosure, the single transmon is coupled to a plurality of modes in a single cavity or resonator.

In accordance with an embodiment of the disclosure, the single cavity comprises cavity comprises a multi-post cavity.

In accordance with an embodiment of the disclosure, the single transmon is coupled to a plurality of modes, the plurality of modes being in a plurality of separated cavities, resonators, or a combination thereof.

In accordance with an embodiment of the disclosure, the single transmon is coupled to one mode per cavity.

In accordance with an embodiment of the disclosure, the one or more non-linear element comprising one or more qubits.

In accordance with an embodiment of the disclosure, the method further comprises one or more calibration steps, the one or more calibration steps comprising: one or more single mode ECD calibration steps.

Other aspects, features and/or advantages will become apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 illustrates schematically a top view of an exemplary single-unit cQED device in accordance with an embodiment of the present disclosure;

FIGS. 2A and 2B illustrate an exemplary multi-unit architecture for GKP qubits in accordance with an embodiment of the present disclosure;

FIG. 3 illustrates a photograph of a top view of the interior of the syndrome auxiliary chip where both coupler chip from units A and B extending therefrom, in accordance with an embodiment;

FIG. 4 illustrates an exemplary, prior art system for a control gate, referred to as an “echoed conditional displacement” (ECD) gate, for control and entanglement of a single-mode system, in accordance with an embodiment;

FIG. 5A and FIG. 5B illustrate an exemplary intra-unit ECD gate in accordance with an embodiment of the present disclosure;

FIG. 6A and FIG. 6B illustrate an inter-unit multimode ECD gate in accordance with an embodiment of the present disclosure;

FIG. 7 illustrates schematically, a novel, multi-mode, entangling gate in accordance with an embodiment of the present disclosure;

FIG. 8 illustrates the simplest protocol involving a two-mode ECD in accordance with an embodiment of the present disclosure;

FIG. 9A illustrates an exemplary single-mode ECD in accordance with an embodiment of the present disclosure;

FIG. 9B, FIG. 9C and FIG. 9D illustrate exemplary two-mode ECDs in a multimode unit in accordance with an embodiment of the present disclosure.

FIG. 10 illustrates, schematically, scaling the number of modes per unit with a multi-mode ECD in accordance with an embodiment of the present disclosure;

FIG. 11 illustrates a double-post cavity for two-mode storage, having an auxiliary chip (transmon+resonators) in accordance with an embodiment of the present disclosure; and

FIG. 12A and FIG. 12B illustrate, schematically, an exemplary multi-unit architecture for GKP qubits in accordance with an embodiment of the present disclosure.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z. (e.g., XYZ, XY, YZ, ZZ, and the like). Similar logic may be applied for two or more items in any occurrence of “at least one . . . ” and “one or more . . . ” language.

The system and method described herein provide, in accordance with different embodiments, different examples of a novel quantum gate architecture for multimode cQED systems. The gate is as easy to calibrate than the single ECD gate, thus providing more control over multimode systems without any added complexity.

In some embodiments, the gate may be implemented by using a single non-linear superconducting element (such as a transmon) coupled to multiple linear modes (e.g., of a superconducting cavity, resonator, etc.). By driving many of the linear modes, the interaction is enhanced enabling the entangling gate to be performed using a protocol that will be described below. By choosing to drive selected modes and not others produces a selective entangling gate between the driven modes.

In some embodiments, the gate may be used with different configurations, including but not limited to:
a single transmon coupled to several cavities/resonators; or
a single transmon coupled to several modes of a single cavity/resonator, such as a multi-post cavity.

Other embodiments may be considered as well, for example multimode modes in separated cavities or resonators, using one mode per cavity or multimode cavities coupled to a non-linear element (e.g., a superconducting qubit such as a transmon, or other types of qubits—including spin qubits).

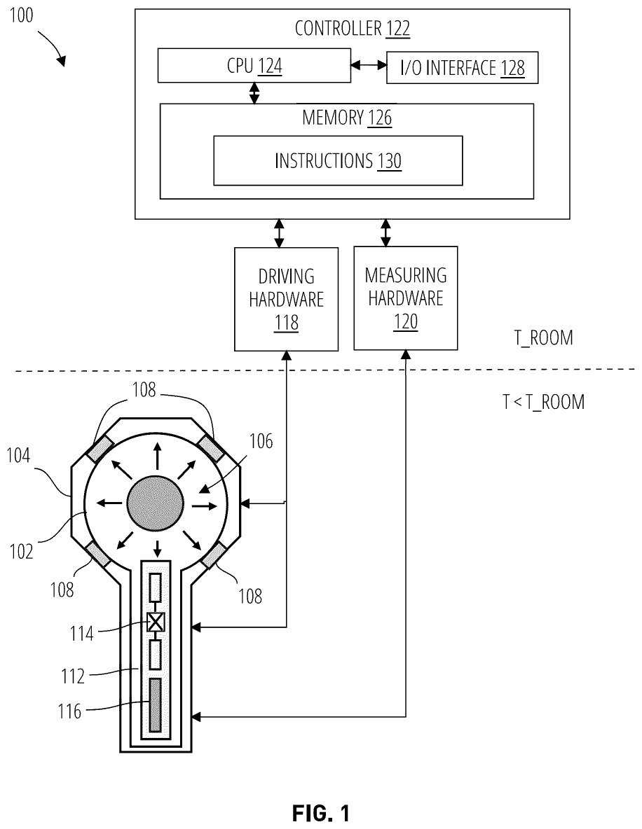

FIG. 1 illustrates schematically a top view of an exemplary single-unit cQED device 100, in accordance with one embodiment, that comprises a 3D superconducting microwave cavity 102. The cavity 102 comprises a casing or housing 104 having an octagonal profile that can be used to implement multi-unit architectures. The superconducting cavity 102 is typically a three-dimensional seamless coaxial-type superconducting microwave cavity configured to house and sustain therein long-lived microwave modes 106 using a rotation-symmetric electric field. The three-dimensional superconducting microwave cavity 102 is configured to host and maintain therein a plurality of long-lived bosonic codes or qubits, such as Gottesman-Kitaev-Preskill (GKP) qubit. However, other bosonic codes or qubits known in the art may also be used or implemented by the cavity 102, for example cat qubits or binomial qubits or others.

The three-dimensional superconducting microwave cavity 102 is designed to have a casing 104 comprising eight external vertical side walls, with some comprising coupling ports 108 allowing to build multi-unit architectures in an extensible square array configuration. In some embodiments, the ancilla resources 112 may comprise an ancillary transmon 114 and linear readout resonator 116. The readout resonator 116 is dispersively coupled to the transmon 114 and may be used, at least in part, to control and read the transmon state. Different types of resonators known in the art may be considered, including for example one or more Purcell filtered resonators. The skilled person in the art will appreciate that different techniques or implementations of an ancilla resources is known in the art that the illustrated device is used as an example only.

The driving hardware 118 typically comprises one or more microwave generators and an arbitrary waveform generator (AWG) or other configured to generate coherent microwave drives and pulses. These may be used for example to prepare or initialize the transmon in a given state using control pulses. The one or more generators are typically coupled via one or more transmission lines to the cavity 102 using for example a cavity control port (not shown) and to the ancilla resources 112—and thus the transmon 114 and the resonator 116—using for example an ancilla control port (not shown).

The measuring hardware 120 is used to read out the state of the transmon 114. Thus, the measuring hardware 120 typically comprises one or more digitizers configured to detect and measure microwave signals or tones scattered off the read-out resonator 116 via a readout port (not shown). The skilled person in the art will understand that different hardware variations and/or techniques may be used to perform the qubit readout, without limitations. It will also be understood that conventional or typical hardware components, such as amplifiers, band-pass filters, up or down converters, analog-to-digital converters (ADC), or others, may also be included in the driving hardware 118 and the measuring hardware 120, without limitations.

Both the driving hardware 118 and the measuring hardware 120 are coupled to a controller 122. The controller 122 is typically provided in the form of a classical computer, which comprises one or more classical processors 124 coupled to a memory 126 and an input/output interface 128. The controller 122 is used to operate the driving hardware 118 and the measuring hardware 120 in accordance with one or more instructions 130 so as to set, control and measure quantum states in the device 100 to implement therewith bosonic codes or qubits, and control logical operations therewith.

In addition, not illustrated in FIG. 1 is a well-known cooling hardware used to maintain the superconducting components, namely the superconducting cavity 102 and the transmon 114, at near-zero Kelvin temperatures. Different means of cooling these components at near-zero Kelvin temperatures well known in the art may be used, without limitations. In contrast, the driving hardware 118, measuring hardware 120 and controller 122, or at least parts thereof, are typically operated at various higher temperatures.

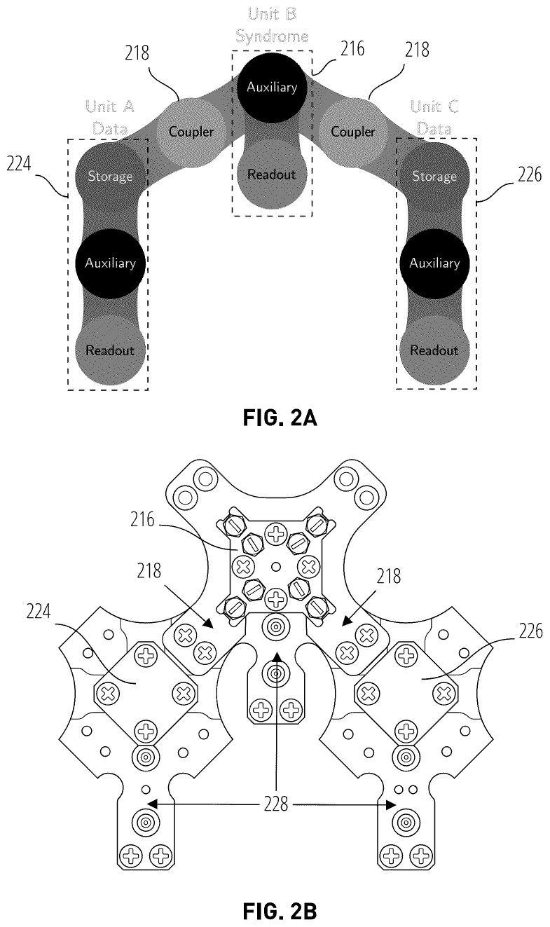

FIG. 2A and FIG. 2B show an exemplary multi-unit architecture for GKP qubits coupling multiple cQED devices, in accordance with one embodiment. In the illustrated architecture, data units (unit A 224 and unit C 226) comprise a storage mode coupled to one or more auxiliary chips 228. The auxiliary chip 228 in this example is comprised of a transmon 114 coupled to one or more resonators (e.g., readout resonators). Each data unit is coupled via passive coupler chips 218 to neighboring sides of a syndrome unit (Unit B 216) comprising an auxiliary chip 228 only.

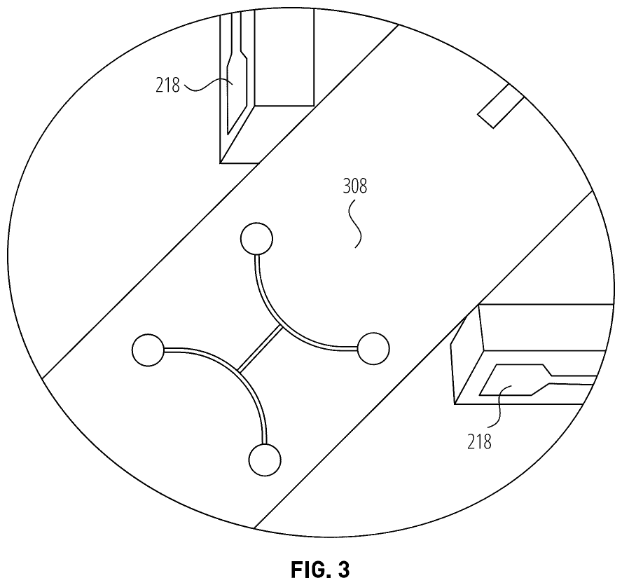

FIG. 3 shows a top view of the interior of the syndrome auxiliary 308 chip where both coupler chips 218 from units A and B extending therefrom.

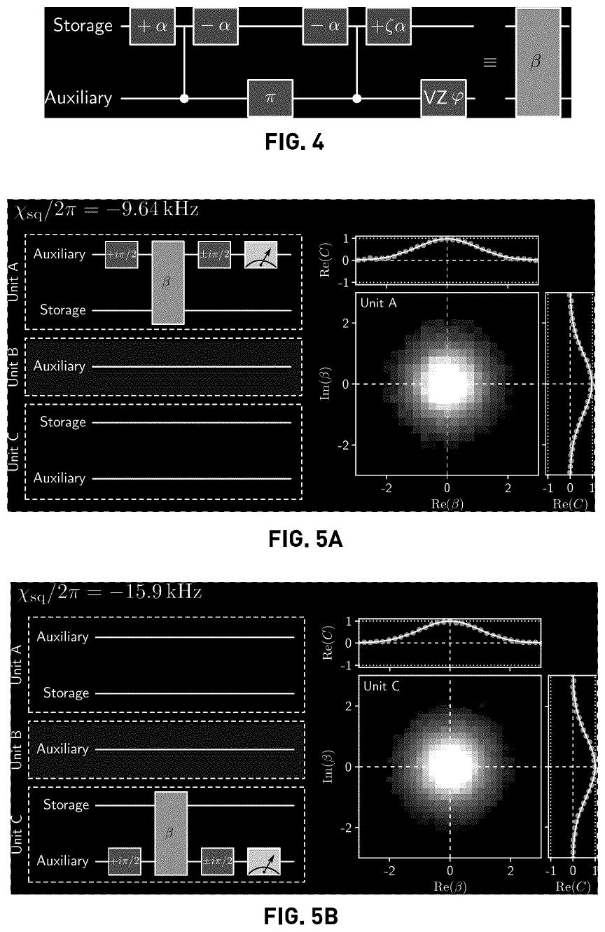

FIG. 4 illustrates an exemplary, prior art system for a control gate, referred to as an “echoed conditional displacement” (ECD) gate, for control and entanglement of a single-mode system.

The ECD protocol is based on unconditional displacements of the storage mode and conditional rotation of the storage mode enabled by the storage-auxiliary cross-Kerr interaction. The last displacement pulse is scaled with parameter ζ to correct for a spurious unconditional displacement. A virtual-Z gate of parameter φ is applied on the auxiliary at the end to correct for a finite geometric phase accumulated during the ECD.

FIG. 5A and FIG. 5B illustrate an exemplary intra-unit ECD gate in accordance with an embodiment of the present disclosure. The intra-unit ECD of FIG. 5A and FIG. 5B comprises a direct auxiliary-storage dispersive interaction. FIG. 5A further demonstrates the protocol for measurement of the characteristic function C(β) within exemplary unit A, wherein the joint characteristic protocol is based on unconditional displacements of a storage mode in unit A and conditional rotation of the storage mode enabled by the storage-auxiliary cross-Kerr interaction. An exemplary measurement of the real part of the characteristic function C(β) in storage mode in a vacuum state is also presented, wherein the measurement is given by the characteristic function:

$${C}_{\vert {0}_{s} )} ( β ) = {e}^{- {\vert β \vert}^{2} / 2}$$

This protocol is run as a first step in the calibration procedure to determine the approximate size of the conditional displacement β resulting from the echoed conditional displacement pulse sequence for a given displacement pulse amplitude A_{S}.

FIG. 5B demonstrates the protocol for measurement of the characteristic function C(β) within exemplary unit C, wherein the joint characteristic protocol is based on unconditional displacements of a storage mode in unit C and conditional rotation of the storage mode enabled by the storage-auxiliary cross-Kerr interaction. Furthermore, an exemplary measurement of the real part of the characteristic function C(β) in storage mode in a vacuum state is presented, wherein the measurement is given by the characteristic function as described above.

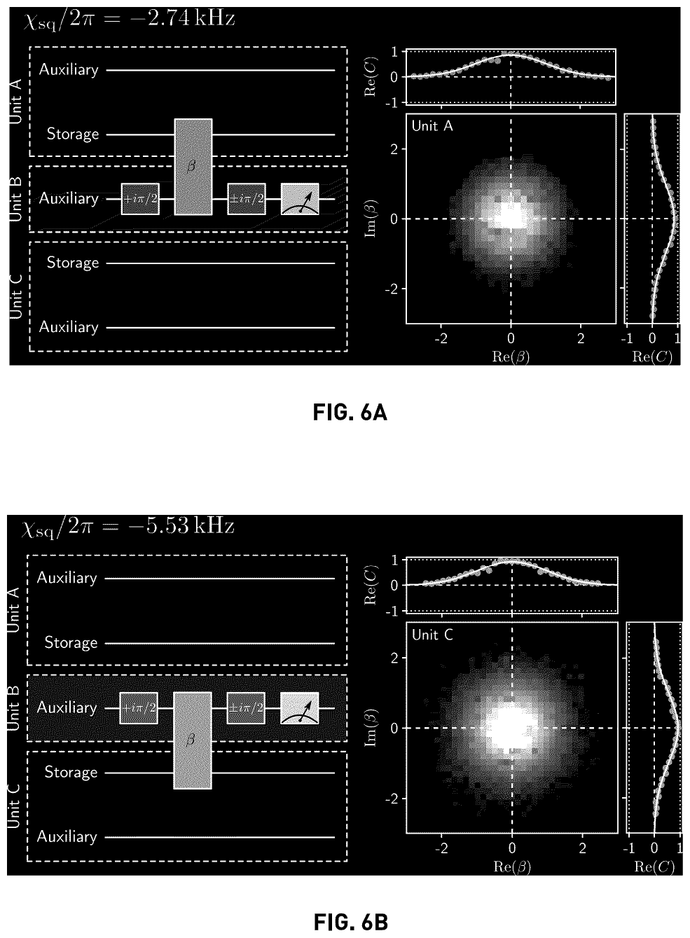

FIG. 6A and FIG. 6B illustrate an inter-unit ECD gate in accordance with an embodiment of the present disclosure. The inter-unit ECD of FIG. 6A and FIG. 6B comprises a coupler-mediated auxiliary-storage interaction. FIG. 6A further demonstrates the protocol for measurement of the characteristic function C(β) between exemplary units A and B, wherein the joint characteristic protocol is based on unconditional displacements of a storage mode in unit A and conditional rotation of the storage mode enabled by the storage-auxiliary cross-Kerr interaction. An exemplary measurement of the real part of the characteristic function C(β) in storage mode in a vacuum state is also presented, wherein the measurement is given by the characteristic function:

$${C}_{\vert {0}_{s} )} ( β ) = {e}^{- {\vert β \vert}^{2} / 2}$$

This protocol is run as a first step in the calibration procedure to determine the approximate size of the conditional displacement β resulting from the echoed conditional displacement pulse sequence for a given displacement pulse amplitude A_{S}.

Moreover, FIG. 6B demonstrates the protocol for measurement of the characteristic function C(β) between exemplary units B and C, wherein the joint characteristic protocol is based on unconditional displacements of a storage mode in unit C and conditional rotation of the storage mode enabled by the storage-auxiliary cross-Kerr interaction. Furthermore, an exemplary measurement of the real part of the characteristic function C(β) in storage mode in a vacuum state is presented, wherein the measurement is given by the characteristic function as described above.

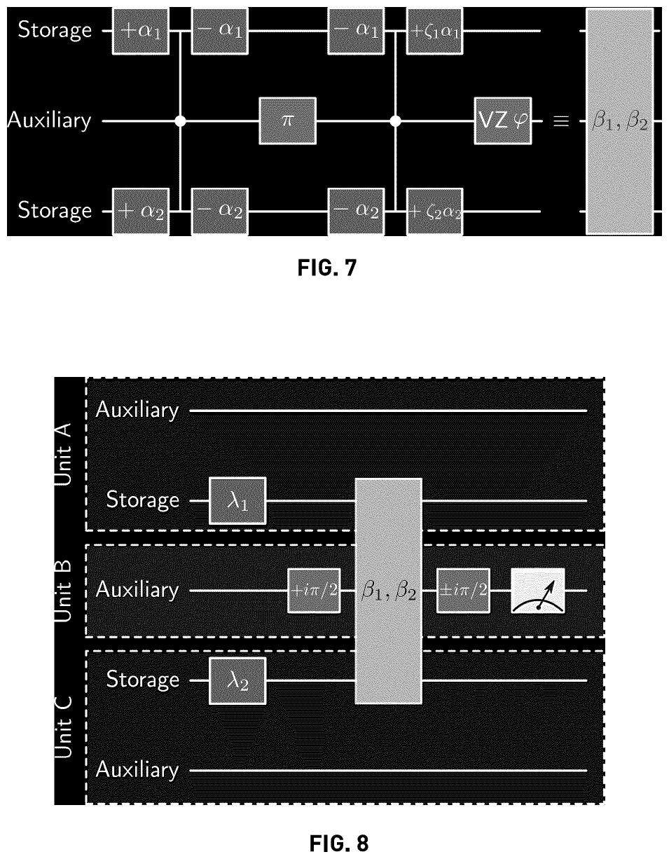

FIG. 7 illustrates schematically, a novel, multi-mode, entangling gate, in accordance with one embodiment, which will be referred to as the two-mode ECD. In this embodiment, the entangling gate is coupled between three elements—two storage modes and an auxiliary qubit, wherein the two storage modes are controlled by the auxiliary qubit. The embodiment described herein, along with other embodiments, allows for universal control and entanglement of multimode systems.

Advantageously, this gate design has independent control of amplitude αₙ in phase space of each of the n mode part of each storage mode. Therefore, there is no need to match dispersive shifts between the storage modes and auxiliary qubit (i.e. the dispersive shift between storage mode 1 and the auxiliary qubit does not need to match the dispersive shift between storage mode 2 and the auxiliary qubit).

The multimode ECD may comprise a first set of displacement drives of amplitude αₙ in phase space of each of n modes involved in the multimode ECD, the first set of displacement drives being followed by one or more of: a wait time, an additional displacement drive of −αₙ, π-pulse on the auxiliary qubit, a −αₙ displacement pulse, a ζₙαₙ pulse with ζₙ being a correction factor, and a virtual Z-gate on the auxiliary qubit. In an embodiment, the amplitudes and wait time of the pulses in the sequences can be adjusted differently, and the timing between pulses can vary from sequence to sequence.

It should be readily apparent that these steps may be performed in varying orders, times may be increased or decreased, and any of the variables may be kept constant, if desired.

In the illustrated embodiment, a single non-linear superconducting element (e.g. a transmon 114) is coupled to multiple linear modes. The modes may comprise, but are not limited to, superconducting cavities, resonators, and the like. The disclosed multimode ECD requires a complex arrangement of hardware components as opposed to that of a single-mode ECD.

FIG. 8 illustrates the simplest protocol involving a two-mode ECD, in accordance with one embodiment. The simplest protocol configured to measure a joint characteristic function involving exemplary units A, B and C, wherein the joint characteristic protocol is based on unconditional displacements of the two storage modes and conditional rotation of the storage modes enabled by the storage-auxiliary cross-Kerr interaction. The last displacement pulse is scaled with parameter (to correct for a spurious unconditional displacement. A virtual-Z gate of parameter (p is applied on the auxiliary at the end to correct for a finite geometric phase accumulated during the two-mode ECD.

The simplest protocol involving a two-mode ECD is described herein. However, there is a plurality of multimode ECD protocols that can be extended to the multimode ECD gate, including but not limited to the joint characteristic function, multimode state preparation, state stabilization and entanglement of multiple bosonic qubits.

Driving hardware 118 may drive one or more of the linear modes. By driving multiple linear modes, the interaction is enhanced enabling the entangling gate to be performed using a joint characteristic function protocol. In the illustrated embodiment, dispersive shifts 3, for the auxiliary and storage, respectively, are equal (β₁=β₂). An advantage of the disclosed multimode ECD protocol is that the dispersive shifts need not match. The gate can be used/applied in different embodiments for example, but not limited to:
1 single transmon is coupled to several cavities/resonators;
1 single transmon is coupled to several modes in one cavities/resonators;
The cavity could be a multi-post cavity.

Choosing to drive selected modes and not others produces a selective entangling gate between the driven modes. The gate is as simple to calibrate as the single mode ECD, providing more control over multimode system without added complexity. Additional embodiments of the multi-mode ECD may comprise: Multiple modes in separated cavities or resonator, using one mode per cavity or multimode cavities coupled to a non-linear element (e.g. qubits, which may include a superconducting qubit such as a transmon, or other types of qubits, including, but not limited to, spin qubits, trapped ion qubits, photonic qubits, and the like).

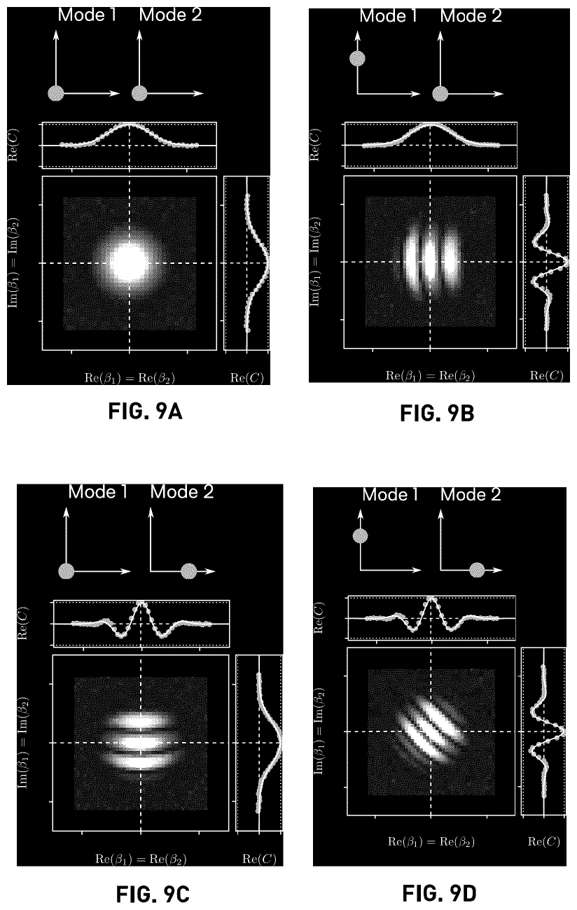

FIG. 9A illustrates an exemplary single-mode ECD in accordance with an embodiment of the present disclosure.

In the illustrated embodiment, phase-space calibration may be conducted from a single-mode ECD.

FIG. 9B to 9D illustrate an exemplary two-mode ECD in accordance with an embodiment of the present disclosure. The completion of calibration depends on the selection of modes. Distortions may be present due to incomplete calibration. Fidelity is limited by low coherence syndrome auxiliary. The figures also reflect exemplary measurements of the real part of the characteristic function C(β) in storage mode in a coherent state, wherein the measurement is given by the characteristic function:

$${C}_{\vert {λ}_{s} )} ( β ) = {e}^{\frac{- {\vert β \vert}^{2}}{2}} cos ( 2 [ Re ( λ ) Im ( β ) + Im ( λ ) Re ( β ) ] )$$

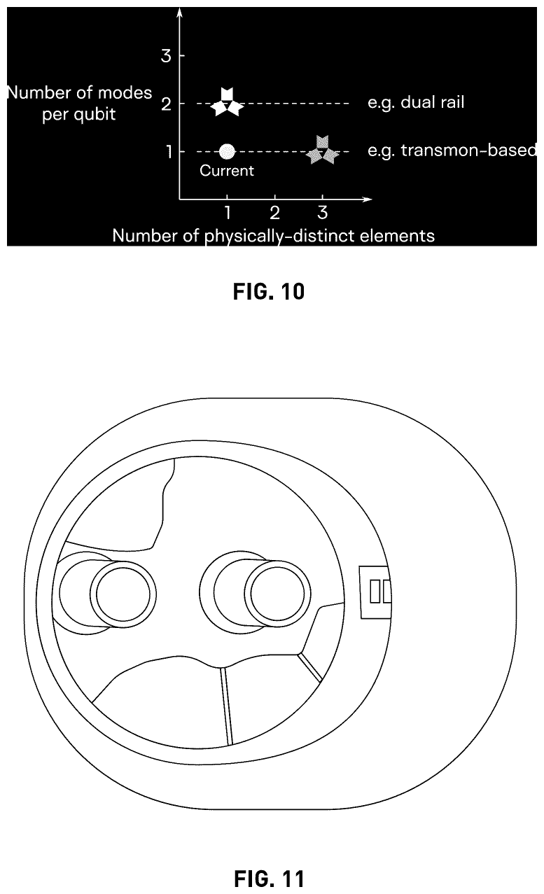

FIG. 10 illustrates, schematically, scaling the number of modes per unit with a multimode ECD. Preferably, increasing the number of modes per unit doesn't require additional hardware (such as, but not limited to, control ports) and enables multiplexed control of multimode systems. The system may be scalable to a plurality of modes.

FIG. 11 illustrates a double-post cavity for two-mode storage, having an auxiliary chip (transmon+resonators), in accordance with an embodiment. The illustrated hardware comprises a single port to address both storage modes, with multiplexed control of both modes.

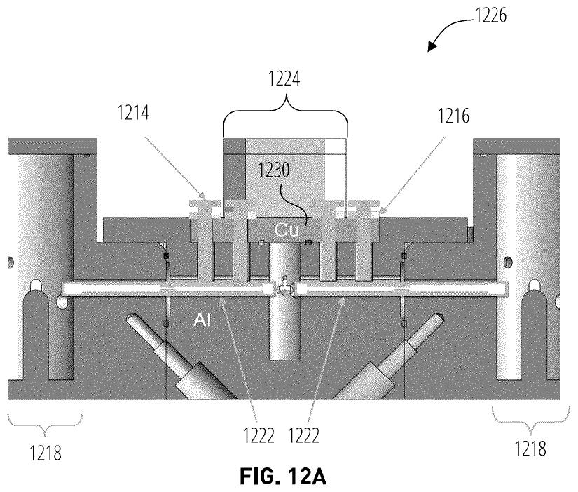

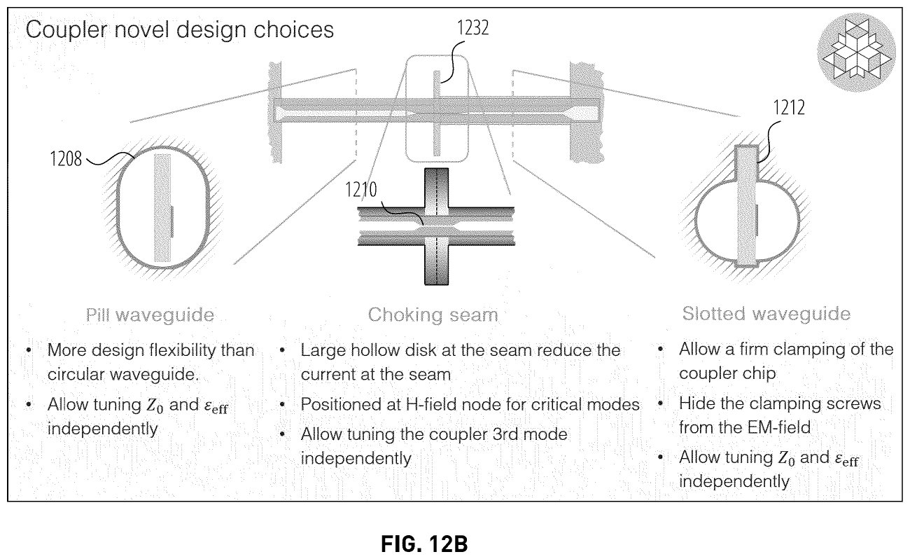

FIG. 12A and FIG. 12B illustrate, schematically, an exemplary multi-unit architecture for GKP qubits in accordance with an embodiment of the present disclosure.

In FIG. 12A, coupler clamping and thermalization hardware 1226 are illustrated. The chip between the units is held by one or more connecting elements 1214 from the top of the syndrome unit. In the illustrated embodiment, the one or more connecting elements 1214 may comprise cryogenic thermally conductive screws, and more specifically, for example brass screws (also referred to as fixing screws) used as connecting elements 1214.

The one or more fixing screws are in contact with the chip and apply a downward force on the coupler chips 1222 ensuring it is properly thermalized to fixing screws and properly anchored in place. To ensure that the screw don't loosen up from mechanical vibration, a jam nut 1216 is inserted on each fixing screw and is tighten against the syndrome cover as illustrated. The storage cavities 1218 are shown on each side of the syndrome cavity 1224.

The syndrome cover 1230 is chosen to be in copper, or any good cryogenic thermal conductor, to provide thermalization to the fixing screws. To ensure a good thermal conduction between the cover and the fixing screws, the cover hosts the fixing screws filet rather than on the syndrome aluminum cavity 1224, ensuring a good mechanical contact between the cover and the fixing screws.

The thermally conductive cover is thermalized with a cryogenic thermally conductive braided metal cable to the dilution fridge's chassis, closing the thermal conduction path between the dilution fridge chassis and the interunit chips (not shown).

FIG. 12B illustrates a coupler design, according to an embodiment of the present disclosure.

The chip between units (interunit chip 1232) is held such that the small side along its length is facing upward and downward as shown.

The interunit chip 1232 is held in the center of the syndrome waveguide 1208 by a slot in this waveguide as shown by the cross-section view of the waveguide at the right of the coupler.

In the illustrated embodiment, the waveguide 1208 comprises a pill waveguide, having more design flexibility than a circular waveguide. Preferably, the pill waveguide 1208 allows tuning of Z₀ and ε_{eff} independently.

A choking seam 1210, positioned at an H-field node for critical modes, comprises, in an embodiment, a large hollow disk at the seam, to reduce the current at the seam. Advantageously, this enables the tuning of a coupler third mode, independently.

In the illustrated embodiment, the coupler design further comprises a slotted waveguide 1212.

The slotted waveguide 1212 functions to allow space to firmly clamp the coupler chip 1222, and to hide/block the clamping screws 1214 from an electromagnetic field. The slotted waveguide 1212 further allows tuning of Z₀ and ε_{eff} independently.

Superconducting circuit devices may be used to operate or control the above elements of the present disclosure. These may comprise a three-dimensional (3D) superconducting microwave cavity configured to host and maintain therein bosonic codes, the cavity comprising a housing having an octagonal profile along a surface, the octagonal profile associated with a first set of four non-adjacent side walls of said cavity and a second set of four non-adjacent side walls of said cavity; the non-adjacent side walls of said first set and said second set perpendicular to the surface; one or more ancilla resources coupled to said cavity via one side wall of said second set of non-adjacent side walls, the one or more ancilla resources protruding away from said cavity along said side wall and configured to, at least in part, control, and measure cavity states therein; a driving hardware comprising one or more microwave generators coupled to said cavity and said one or more ancilla resources and operable to control quantum states thereof; a measuring hardware coupled to said one or more ancilla resources and configured to measure microwave signals associated with said quantum states; a controller operably coupled to said driving hardware and said measuring hardware so as to operate said device.

It will be understood that the expression classical or conventional “computer”, or “controller”, as used herein is not to be interpreted in a limiting manner. “computer” is rather used in a broad sense to generally refer to the combination of some form of one or more processing units and some form of memory system accessible by the processing unit(s). “Controller” is used in a broad sense to generally refer to a device which performs a function of controlling, and may be a computer or another type of device. The memory system if a computer can be of the non-transitory type. The use of the expression “computer” in its singular form as used herein includes within its scope the combination of a two or more computers working collaboratively to perform a given function, independently of whether these two or more computers are local, remote, or distributed. Moreover, the expression “computer” as used herein includes within its scope the use of partial capabilities of a given processing unit.

A processing unit can be embodied in the form of a general-purpose micro-processor or microcontroller, a digital signal processing (DSP) processor, an integrated circuit, a field programmable gate array (FPGA), a reconfigurable processor, a programmable read-only memory (PROM), to name a few examples. The memory system can include a suitable combination of any suitable type of computer-readable memory located either internally, externally, and accessible by the processor in a wired or wireless manner, either directly or over a network such as the Internet.

A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A system for control and entanglement of multimode quantum computing devices, the system comprising:
a single non-linear superconducting element coupled to one or more linear modes;
a controller coupled to the single non-linear superconducting element and configured to perform, via a driving hardware, a multimode Echoed Conditional Displacement (ECD) protocol, the multimode ECD protocol configured to selectively drive the one or more linear modes in order to achieve an entangling gate between the one or more linear modes.

2. The system of claim 1, the multimode ECD comprising performing, by the driving hardware:
a first set of displacement drives of amplitude αₙ in phase space of each of n modes involved in the multimode ECD protocol;
the first set of displacement drives being followed by one or more of: a wait time, an additional displacement drive of −αₙ, π-pulse on the auxiliary qubit, a −αₙ displacement pulse, a ζαₙ pulse with ζ being a correction factor, and a virtual Z-gate on the auxiliary qubit.

3. The system of claim 1, wherein the single, non-linear superconducting element comprises a single transmon.

4. The system of claim 1, wherein the one or more linear modes comprise: superconducting cavities, resonators, or a combination thereof.

5. The system of claim 3, wherein the single transmon is coupled to a plurality of cavities, resonators, or a combination thereof.

6. The system of claim 3, wherein the single transmon is coupled to a plurality of modes in a single cavity or resonator.

7. The system of claim 6, wherein the cavity comprises a multi-post cavity.

8. The system of claim 3, wherein the single transmon is coupled to a plurality of modes, the plurality of modes being in a plurality of separated cavities, resonators, or a combination thereof.

9. The system of claim 3, wherein the single transmon is coupled to one mode per cavity.

10. The system of claim 3, wherein the single transmon is coupled to one or more multimode cavities, the one or more multimode cavities being coupled to one or more non-linear elements.

11. The system of claim 3, the one or more non-linear comprising one or more qubits.

12. The system of claim 5, wherein a calibration of the system comprises: one or more single mode ECD calibration steps.

13. A method of controlling and entangling a multimode system, the method comprising selectively driving, via a multimode Echoed Conditional Displacement (ECD) protocol, one or more linear modes, the one or more linear modes coupled to a single non-linear superconducting element, in order to achieve an entangling gate between the one or more linear modes.

14. The method of claim 13, the multimode ECD comprising:
a first set of displacement drives of amplitude αₙ in phase space of each of n modes involved in the multimode ECD protocol;
the first set of displacement drives being followed by one or more of: a wait time, an additional displacement drive of −ζαₙ, π-pulse on the auxiliary qubit, a −αₙ displacement pulse, a ζαₙ pulse with ζ being a correction factor, and a virtual Z-gate on the auxiliary qubit.

15. The method of claim 13, wherein the single, non-linear superconducting element comprises a single transmon.

16. The method of claim 13, wherein the single, non-linear superconducting element comprises a single transmon.

17. The method of claim 13, wherein the one or more linear modes comprise: superconducting cavities, resonators, or a combination thereof.

18. The method of claim 15, wherein the single transmon is coupled to a plurality of modes in a single cavity or resonator.

19. The method of claim 18, wherein the cavity comprises a multi-post cavity.

20. The method of claim 15, wherein the single transmon is coupled to a plurality of modes, the plurality of modes being in a plurality of separated cavities, resonators, or a combination thereof.
